(19) United States
(12) Patent Application Publication
(10) Pub. No.: US 2005/0284220 A1
(43) Pub. Date: Dec. 29, 2005

(54) Float arm assembly and method of manufacture

(76) Inventors: Kenneth J. Cotton, Caro, MI (US); Daniel H. Kallio, Iron River, MI (US); Richard J. Parrott II, Cass City, MI (US)

Correspondence Address: REISING, ETHINGTON, BARNES, KISSELLE, P.C., P O BOX 4390, TROY, MI, 48099-4390, US

(21) Appl. No.: 10/879,389

(22) Filed: Jun. 29, 2004

(51) Int. Cl. G01F 23/76; G01F 23/32; B29C 39/10; B29C 45/14; B29C 49/20

(52) U.S. Cl. 73/322.5; 73/317; 264/328.1; 264/138; 264/299

(57) ABSTRACT

A float arm assembly and method of construction therefore has a float arm with a free end and another end arranged for operable communication with a float arm position sensor. A float is molded to the float arm to provide a unitary and rigid float arm assembly.

### FIELD OF THE INVENTION

This invention relates generally to fuel systems and more particularly to fuel level senders for use in a fuel tank.

### BACKGROUND OF THE INVENTION

Vehicles having internal combustion engines typically have fuel tanks for maintaining liquid fuel therein. Generally, the fuel tank has a fuel level sender therein to provide an indication to a user, such as on a fuel level gauge, as to the amount of fuel within the tank. Commonly, the fuel level sender incorporates a float arm assembly having a float arm extending through a float to facilitate attaching the float on the float arm. Further, it is known to use at least one or more washers received adjacent opposite ends of the float in combination with a fastener, such as a self locking Tinnerman® style washer or threaded nut to maintain the float fastened to the float arm.

By securing a float to a float arm through the use of fasteners, typically performed in a secondary operation, variances result from one float arm assembly to another as a result of the stack up tolerances between the various components. The resulting variances affect the performance of the float arm, and thus, affect the accuracy of the fuel level reading indicated to a user. As a result, the user receives a potentially misleading value as to the quantity of fuel remaining in the fuel tank. Additionally, the fasteners used in securing the float to the float arm add additional weight to the assembly, thereby impacting the buoyancy of the float within the fuel, and thus, affecting its performance. Further, the secondary operations performed in using fasteners to secure the float to the float arm complicate the assembly process, and thus, increase the costs associated with assembling of the float arm assembly.

### SUMMARY OF THE INVENTION

A float arm assembly for use in a fuel tank has a float arm with a free end and another end arranged for operable communication with a float arm position sensor. The assembly has a float molded to the float arm to provide a unitary and rigid float arm assembly.

Another aspect of the invention includes a method of constructing a float arm assembly for use in a fuel tank. The steps include providing a float arm having a free end and another end arranged for operable communication with a float arm position sensor. Further, molding a float to the float arm to provide a unitary and rigid float arm assembly.

The float arm assembly and method of manufacture therefore provides a float arm assembly that is moveable within a fuel tank in response to a continuously varying fuel level within the fuel tank to provide accurate readings of the fuel level within the fuel tank. With the float being molded to the float arm, the stack up tolerances resulting between the float and the float arm are kept to a minimum, thereby reducing the potential for variances from one float arm assembly to another, and further, improving the accuracy of the fuel level readings. Additionally, the method of construction of the float arm assembly eliminates the need for secondary operations to assemble the float arm to the float, thereby enhancing the manufacturing efficiencies and reducing the costs generally associated with secondary operations, such as labor, capital equipment, floor space and component costs, for example.

Some of the objects, features and advantages included in at least some of the disclosed embodiments of the invention include providing a float arm assembly for use in a fuel tank that has a reduced number of component parts, provides a float arm assembly facilitating repeatable and reliable fuel level readings, reduces potential stack up tolerance variations in assembly and problems associated therewith in use, minimizes the weight of a float arm assembly, maximizes the buoyancy of a float on a float arm assembly, improves the manufacturing efficiencies for a float arm assembly, maximizes the potential volume for a float on a float arm assembly, allows optimization of the geometry of a float on a float arm assembly, allows optimal design of a float arm to improve the buoyancy of a float attached thereto, is of relatively simple design and provides for a long and useful life in use.

### BRIEF DESCRIPTION OF THE DRAWINGS

These and other objects, features and advantages of this invention will be apparent from the following detailed description of the preferred embodiments and best mode, appended claims and accompanying drawings, in which:

FIG. 1 is a perspective view of a fuel level sender having a float arm assembly constructed according to one embodiment of the invention;

FIG. 2 is a partial cross-sectional view of a fuel tank with the fuel level sender of FIG. 1 shown received within the fuel tank;

FIG. 3 is a partial cross-sectional view of the float arm assembly of FIG. 1 having a float arm with a float molded thereto;

FIG. 4 is a partial cross-sectional view of a float arm assembly constructed according to another embodiment of the invention having a float arm with a float molded thereto;

FIG. 5 is a partial cross-sectional view of a float arm assembly constructed according to yet another embodiment of the invention having a float arm with a float molded thereto;

FIG. 6 is a partial cross-sectional view of a float arm assembly constructed according to yet another embodiment of the invention having a float arm with a float molded thereto; and

FIG. 7 is a partial cross-sectional view of a float arm constructed according to yet another embodiment of the invention.

### DETAILED DESCRIPTION OF THE PREFERRED EMBODIMENTS

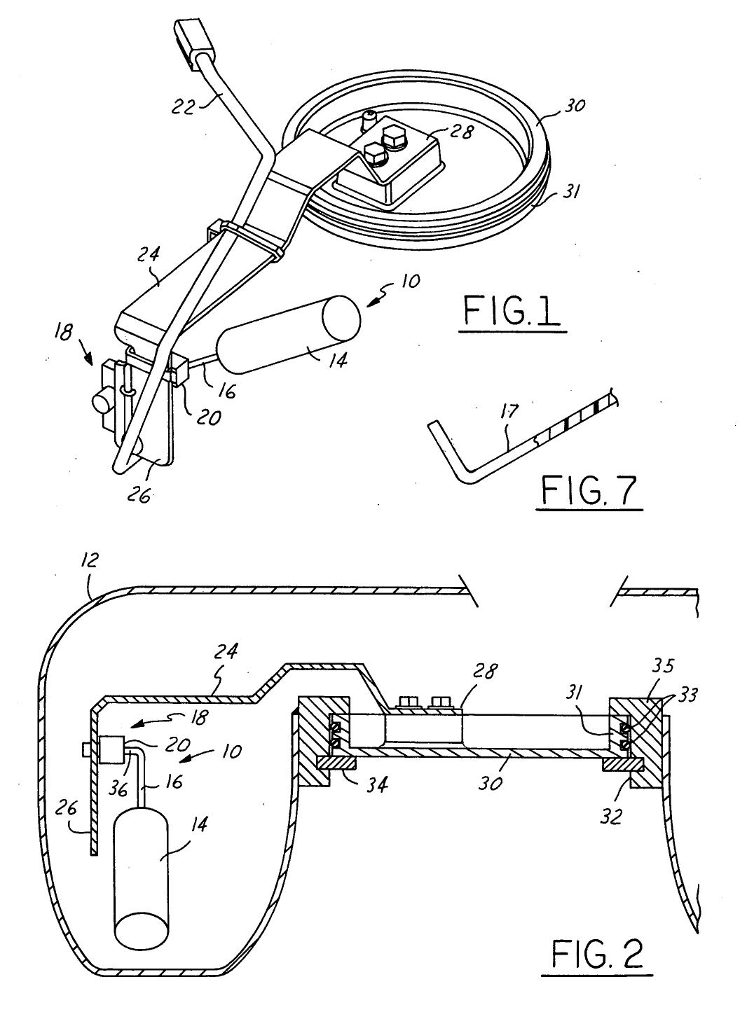

Referring in more detail to the drawings, FIGS. 1 and 2 illustrate a float arm assembly 10 constructed according to one embodiment of the invention. The float arm assembly 10 is constructed for use within a fuel tank 12 (FIG. 2), such as a fuel tank on a motorcycle, recreational vehicle or an automobile, for example. The assembly 10 has a float 14 molded onto or over at least a portion of a float arm 16, such that the float 14 is carried by the float arm 16 and may be fixed thereto to eliminate or reduce slop or play between the float 14 and the float arm 16. As a result, the float arm assembly 10 is responsive to a change in the fuel level within the fuel tank 12 preferably with little, and more preferably without any relative movement between the float 14 and the float arm 16, thereby facilitating a relatively accurate determination of the level of fuel in the fuel tank.

The float arm assembly 10 is generally constructed for use as a component of an electromechanical fuel level sender 18, although it can be used with substantially any type of fuel level sender or indicator including, without limitation, mechanical level indicators. In use, the float arm 16 moves between a first position corresponding to a position in which the fuel tank 12 is generally empty (FIG. 2), and a second position corresponding to a position in which the fuel tank 12 is generally full of liquid fuel (FIG. 1). The float arm 16 moves in response to the movement of the float 14 which is buoyant in liquid fuel, and hence, is responsive to changes in the level of fuel in the fuel tank. As the float arm 16 moves between its first and second positions, an electrical sensor 20 detects the position of the float arm 16, such as through a change in a voltage reading, for example, and communicates this position through an electrical signal via a wire harness 22 to a control circuit or fuel tank control unit (not shown). The electrical signal received by the control circuit, for example, is generally processed through a preprogrammed algorithm that determines the level of fuel within the fuel tank 12 as a function of the electrical signal. Accordingly, the accuracy of the fuel level signal sent by the electrical sensor 20 plays a role in the accuracy of the fuel level indicated to a user.

The fuel level sender 18 is shown here as being attached to a bracket 24 adjacent one end 26 of the bracket 24, wherein the bracket 24 has another end 28 attached to a mount flange 30. The mount flange 30 is shown in FIG. 2 fastened within an opening 32 of the fuel tank 12 to position the float arm assembly 10, as desired, within the fuel tank 12. The mount flange 30 is secured within the opening 32 using any suitable attachment mechanism, such as a snap ring or c-clip 34 to maintain the mount flange 30, and thus, float arm assembly 10 in its desired position within the fuel tank 12. The mount flange 30 has a generally cylindrical sidewall 31 with one or more grooves to receive one or more seals 33 between the flange 30 and the fuel tank or an insert 35 carried by the fuel tank. The fuel tank 12 is represented here by example as a saddle-type motorcycle fuel tank, though it should be recognized that the float arm assembly 10 is intended for use in any fuel tank application, such as in automobiles or recreational vehicles, and can be employed with any suitable mount or otherwise supported or carried as desired, by way of examples and without limitation.

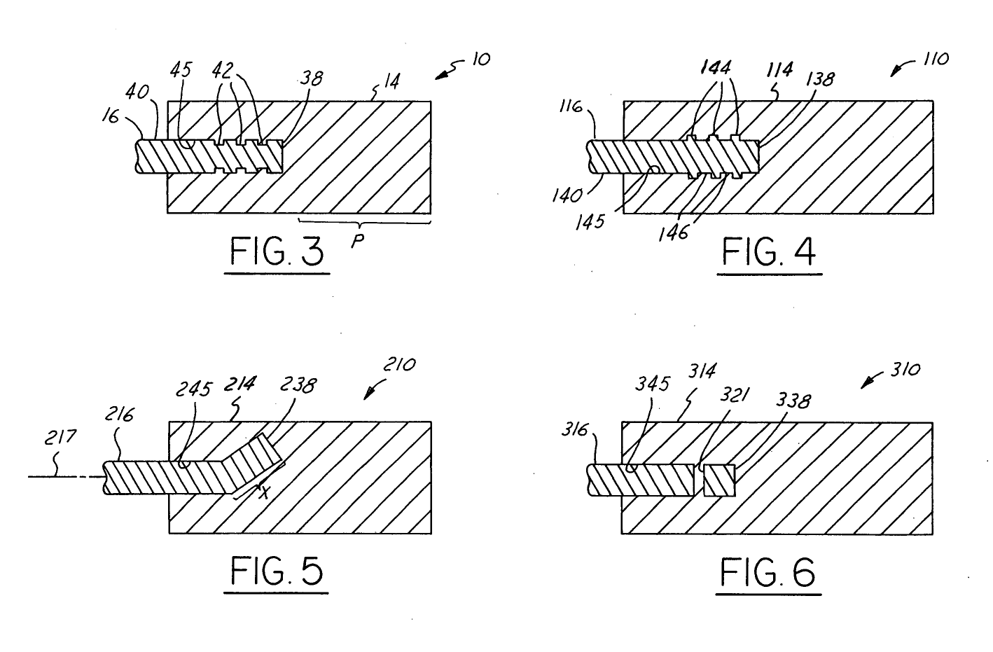

The float arm 16 is desirably constructed from an elongate rod having one end 36 arranged for operable attachment to the electrical sensor 20 and a free end 38 (FIG. 3). The float arm 16 may be constructed having any suitable outer geometry, such as cylindrical, rectangular, or otherwise, as desired. Desirably, the float arm 16 is formed to its desired finished size and shape, depending on the application envelope, and thereafter is positioned at least in part within a mold cavity of an injection mold or blow mold so that the float 14 may be molded onto or over the end 38 of the float arm 16. It should be recognized that additional operations may be performed on the float arm 16 after molding the float 14 to the float arm 16, and that the float arm 16 need not be in its final state or form prior to molding the float 14 to the float arm 16.

The float arm 16 is preferably constructed from a metallic material, such as stainless steel or galvanized music wire, for example, or, as represented in an alternate embodiment in FIG. 7, a float arm 17 may be formed as an extruded or molded polymeric material. To avoid degradation to the float arm 16 while molding the float 14 thereto, if a polymeric material is used in constructing the float arm 16, the polymeric material can be chosen to have a higher melt point than the material used in constructing the float 14. Some types of polymeric materials that may be used, by example and without limitation, include an acetal having a melt temperature of about 320-375° F. (Delrin® or Celcon, for example), a polyamide having a melt temperature of about 350-510° F. (Nylon, for example) or a polyphthalimide having a melt temperature of about 590° F. (Amodel®, for example).

The float arm 16 preferably has an attachment feature to retain the float 14 on the float arm 16. As shown in FIG. 3, the attachment feature or features of the float arm 16 includes one or more voids such as cavities or grooves 42 extending radially inwardly from an outer surface 40 of the float arm 16. Desirably, the grooves 42 span circumferentially about the float arm 16, and are shown here as being axially spaced from one another. It should be understood that the grooves 42 may take on any geometric pattern, such as a helical configuration commonly used for threads, or may be discontinuous about the circumference of the float arm 16, such as in the formation of slots or other void configurations. In addition, the geometry of the grooves 42 may be generally square-shaped, v-shaped, or otherwise configured, as desired.

The float 14 is constructed from any suitable float material having the desired density properties required to provide a desired buoyancy for the float 14 in use. Some types of materials that may be used, by example and without limitation, include a foamed-nylon having a mold temperature of about 175-210° F., Nitrophyl having a mold temperature of about 375° F. or an acetal having a mold temperature of about 175-210° F.

As shown in FIG. 3, the float 14 is preferably molded on the float arm 16 so that the float material extends at least partially into the grooves 42 to form a discontinuous passage 45 within the float 14, and desirably substantially fills the grooves 42 in the float arm 16 during the molding process. As such, the float 14 is preferably rigidly attached to the float arm 16. Desirably, the float 14 extends axially beyond the end 38 of the float arm 16 such that at least a portion (P) of the float 14 is devoid of the float arm 16 in lateral cross section such that the discontinuous passage 45 is formed as an enclosed cavity within the float 14 and so that the free end 38 of the float arm 16 is encapsulated by the float 14. Accordingly, the length of the float arm 16 can be minimized, thereby minimizing the weight of the float arm 16. By minimizing the length and weight of the float arm 16, the envelope required to house the float arm assembly can be reduced, and the buoyancy of the float 14 can be maximized. Furthermore, the number and types of useful applications for which the float arm assembly 10 may be incorporated are enhanced by allowing for varying configurations of the float 14, as best meets the specific application needs.

As shown in FIG. 4, another embodiment of a float arm assembly 110 is shown wherein a float arm 116 has a float 114 molded thereto. The float arm 116 has an outer surface 140 terminating at a free end 138 with at least one and shown here as a plurality of attachment features or protrusions 144 extending radially outwardly from the outer surface 140 generally adjacent the free end 138. The protrusions 144 define at least in part the attachment feature and are shown being axially spaced from one another to define annular channels 146 between adjacent protrusions 144. The protrusions 144 are represented here as extending circumferentially and radially about the float arm 116, though it should be recognized that the protrusions 144 may extend at any orientation including radially, may be discontinuous about the circumference of the float arm 116 to provide outwardly extending tabs or fingers, and also can take on the construction of a helical thread pattern, by way of example and without limitation.

The float 114 is preferably molded to the float arm 116 such that the free end 138 of the float arm 116 is preferably encapsulated by the float 114. The float 114 desirably extends at least partially and preferably substantially occupies the channels 146 between the protrusions 144 during the molding process, thereby forming a discontinuous passage 145 within the float 114. Otherwise, the float 114 may be constructed generally the same as the float 14 in the previous embodiment, and thus, is not discussed further.

As shown in FIG. 5, another embodiment of a float arm assembly 210 is shown wherein a float arm 216 has a float 214 molded thereto. The float arm 216 has a longitudinal axis 217 with at least a portion (X) of the float arm 216 adjacent a free end 238 of the float arm 216 being inclined or bent relative to the longitudinal axis 217 to define the attachment feature retaining the float 214 on the float arm 216.

The float 214 is preferably molded to the float arm 216 such that the free end 238 of the float arm 216 is preferably encapsulated by the float 214. With the float arm 216 being bent or inclined within the material of the float 214, the float 214 is formed having a discontinuous passage 245 with at least one bend therein to further assure that the float 214 is positively retained on and generally rigidly fixed to the float arm 216. The inclined portion (X) resists removal of the float 214 from the float arm 216, particularly along the direction of the longitudinal axis 217. Otherwise, the float 214 may be constructed generally the same as described in the previous embodiments, and thus, is not discussed further.

As shown in FIG. 6, another embodiment of a float arm assembly 310 is shown wherein a float arm 316 has a float 314 molded thereto. The float arm 316 terminates at a free end 338 and has an attachment feature including an opening extending into the float arm 316, and preferably a through hole 321 extending through the float arm 316 generally adjacent the free end 338.

The float 314 is molded to the float arm 316 such that the free end 338 of the float arm 316 is preferably encapsulated by the float 314. The material of the float 314 desirably flows at least partially and preferably substantially within the through hole 321 during the molding process to retain the float 314 on the float arm 316 in use. Accordingly, the float 314 has a discontinuous passage 345 resulting from the material of the float 314 entering the through hole 321. It should be recognized that although only one through hole is shown, a plurality of through holes could be formed in the float arm 316. Otherwise, the float 314 may be constructed the same as described in the previous embodiments, and thus is not discussed further.

It should be recognized that the embodiments of the float arm assembly discussed above are intended to be illustrative of some presently preferred embodiments of the invention, and not limiting. Various modifications within the spirit and scope of the invention will be readily apparent to those skilled in the art. For example, without limitation, the float arms in the embodiments above may have a portion of the float arm exposed external to the float molded thereto, and further, any of the features of the float arm embodiments above may be combined with one another, as desired. Additionally, the float does not have to be perfectly rigidly attached to the float arm, some play or movement of the float relative to the float arm may occur. Even if initially rigidly attached to the float arm, dimensional changes of the float or float arm may introduce some play or movement between them. Further, while several examples of floats with discontinuous passages have been shown and described other float configurations having passages (blind or through bores or passages), that are not right cylindrical passages with generally smooth and continuous surfaces, can be employed. The invention is defined by the claims that follow.

1. A float assembly for use in a fuel tank, comprising:
a metal float arm; and
a float molded as a single piece directly onto at least a portion of the float arm so that the float is carried by the float arm.

2. The assembly of claim 1 wherein the float arm has a free end and the float extends at least in part beyond the free end.

3. The assembly of claim 1 wherein the float arm includes at least one attachment feature that retains the float on the float arm and over which the float is molded.

4. The assembly of claim 3 wherein the attachment feature includes a groove formed therein with the float extending at least partially into the groove.

5. The assembly of claim 4 wherein the float arm has a plurality of grooves formed therein with the float extending at least partially into the grooves.

6. The assembly of claim 3 wherein the attachment feature includes a bent portion of the float arm.

7. The assembly of claim 6 wherein said bent portion is located adjacent a free end of the float arm.

8. The assembly of claim 2 wherein the free end is encapsulated by the float.

9. The assembly of claim 3 wherein attachment feature includes a protrusion on the float arm.

10. The assembly of claim 9 wherein the float arm has a plurality of protrusions with a channel being defined between each pair of adjacent protrusions and said float extending within said channels.

11. The assembly of claim 10 wherein said float substantially occupies said channels.

12. The assembly of claim 3 wherein the attachment feature includes a hole formed in the float arm with the float extending at least partially into the hole.

13. (canceled)

14. The assembly of claim 1 wherein the material of the float arm has a melt temperature greater than the mold temperature of the material of the float.

15. (canceled)

16. A method of constructing a float arm assembly for use in a fuel tank, comprising the steps of:
providing a float arm;
arranging the float arm in a mold cavity; and
molding a substantially solid float over at least a portion of the float arm.

17. The method of claim 16 wherein the molding step is performed by injection molding the float onto the float arm.

18. The method of claim 16 wherein the molding step is performed by blow molding the float onto the float arm.

19. The method of claim 16 including forming the float arm from a polymeric material.

20. The method of claim 19 including constructing the float arm from a material having a higher melt point than the material of the float.

21. The method of claim 19 including injection molding the float arm.

22. The method of claim 19 including extruding the float arm.

23. The method of claim 22 including forming at least one bend in the float arm after the extruding step.

24. The method of claim 16 wherein the float arm is provided having a free end and including molding the float so that at least a portion of the float extends outwardly beyond the free end.

25. The method of claim 16 including the step of forming a groove in the float arm prior to the molding step.

26. The method of claim 25 including molding the float so that at least a portion of the float extends into the groove.

27. The method of claim 16 including the step of bending the float arm prior to the molding step.

28. The method of claim 16 including the step of forming a protrusion on the float arm prior to the molding step and wherein the molding step includes molding the float over the protrusion.

29. The method of claim 28 including forming the float arm with a plurality of protrusions to define a channel between adjacent protrusions.

30. The method of claim 29 wherein the molding step includes molding the float so that at least a portion of the float extends into at least one channel.

31. A float arm assembly for use in a fuel tank, comprising:
a float arm; and
a substantially solid float having a discontinuous passage with the float arm being received at least in part within the discontinuous passage.

32. The assembly of claim 31 wherein the discontinuous passage includes at least one bend with the float arm extending through the bend.

33. The assembly of claim 31 wherein the float arm has at least one groove and the discontinuous passage includes at least a portion of the float extending into the grooves.

34. The assembly of claim 33 wherein the float arm has a plurality of grooves and the discontinuous passage includes portions of the float extending into the grooves.

35. The assembly of claim 31 wherein the float arm has a protrusion and the discontinuous passage includes at least a portion of the float disposed around the protrusion.

36. The assembly of claim 35 wherein the float arm has a plurality of protrusions and the discontinuous passage includes portions of the float arm disposed around the protrusions.

37. The assembly of claim 31 wherein the float arm has a hole and the discontinuous passage includes a portion of the float extending into the hole.

38. The assembly of claim 31 wherein the float arm has a free end and the discontinuous passage is constructed as an enclosed cavity substantially encapsulating the free end.

39. The method of claim 16 including the step of forming a hole on the float arm prior to the molding step and wherein the molding step includes molding the float over and at least partially into the hole.
